(19) United States
(12) Patent Application Publication
(10) Pub. No.: US 2008/0245892 A1
(43) Pub. Date: Oct. 9, 2008

(54) Decay prevention structure of a heat dissipating board of a humidifier

(76) Inventor: Ping Huang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/783,311

(22) Filed: Apr. 9, 2007

(51) Int. Cl. B05B 1/08

(52) U.S. Cl. 239/102.2

(57) ABSTRACT

A humidifier includes a water storage tank for storing water, a working tank, a piezoelectric crystal, a filtering unit, and a heat dissipating board; the filtering unit is positioned in the storage tank for filtering water before water is sent from the water storage tank into the working tank; the piezoelectric crystal will vibrate so as to produce ultrasonic waves to break water contained in the working tank into molecules, which will dissolve in air immediately; the heat dissipating board is interposed between an upper side of the piezoelectric crystal and water contained in the working tank so as to be in touch with the water; the heat dissipating board has a decay-prevention stainless steel layer joined to an upper side thereof therefore it is prevented from decaying and rusting.

### BACKGROUND OF THE INVENTION

1. Field of the invention

The present invention relates to a decay-prevention structure of a heating dissipating board of a humidifier, more particularly one, which can effectively prevent the heat dissipating board from decaying, thus allowing heat produced by a piezoelectric crystal of the humidifier to be effectively dissipated to ensure necessary power of ultrasonic vibration of the humidifier.

2. Brief Description of the Prior Art

In order to prevent people from being subjected to bad effects of very dry room air, which can be caused by use of air conditioners and heaters, humidifiers are developed. A common humidifier comprises a water storage tank, and a heater for heating water so as to produce steam, which will be immediately sent out to increase humidity of the room.

A kind of humidifier includes a water storage tank, a conduit, and a heating unit; in use, water flows from the water storage tank to the heating unit through the conduit, and the heating unit heats the water so as to produce steam, which is blown out to the room through an outlet to increase the humidifier of the room by means of a blower.

Another kind of humidifier exploits the ultrasonic vibration principle, capable of breaking water into molecules and making the molecules dissolve in air by means of using ultrasonic vibration. Ultrasonic wave is a kind of mechanical wave, and needs a medium such as water and other kinds of liquids to help its energy pass on in tissues of living things in the form of longitudinal wave. Such a humidifier includes a piezoelectric crystal, which will change in size and vibrate to produce ultrasonic waves when being subjected to piezoelectric effect. And, the ultrasonic waves are passed on to break water into molecules. A large power will be produced when electric energy is being transformed into ultrasonic waves. Therefore, heat produced by the piezoelectric crystal should be efficiently dissipated, and such a humidifier is usually equipped with a heat dissipating board, which is positioned on an upper side of the piezoelectric crystal. Because the heat dissipating board is constantly in touch with water (medium), it is prone to rust and will have a rust layer forming thereon after it has been used for a long period of time. Consequently, heat dissipation effect is reduced, resulting in poorer performance of the piezoelectric crystal. To overcome the above problems, the medium-touched side of the heat dissipating board is usually covered with metal by means of electroplating or coated with Teflon. However, the metal/Teflon coating is prone to peel off after use. Therefore, these approaches to the above-mentioned problems aren't satisfactory.

### SUMMARY OF THE INVENTION

It is a main object of the present invention to provide a decay-free heat dissipating board of a humidifier to overcome the above-mentioned problems.

A humidifier according to an embodiment of the present invention includes a water storage tank, a working tank, a piezoelectric crystal, a filtering unit, and a heat dissipating board. The filtering unit is positioned in the water storage tank for filtering water before water is sent into the working tank. The piezoelectric crystal will vibrate so as to produce ultrasonic waves to break water contained in the working tank into molecules, which will dissolve in air immediately. The heat dissipating board is interposed between an upper side of the piezoelectric crystal and water contained in the working tank so as to be in touch with the water. More particularly, the heat dissipating board has a decay-prevention stainless steel layer on an upper side thereof therefore it isn't possible for the heat dissipating board to decay and rust.

### BRIEF DESCRIPTION OF THE DRAWINGS

The present invention will be better understood by referring to the accompanying drawings, wherein:

FIG. 1 is a sectional view of the present invention,

FIG. 2 is an exploded sectional view of the present invention,

FIG. 3 is a perspective view of the present invention, and

FIG. 4 is a sectional view of the present invention.

### DETAILED DESCRIPTION OF THE PREFERRED EMBODIMENTS

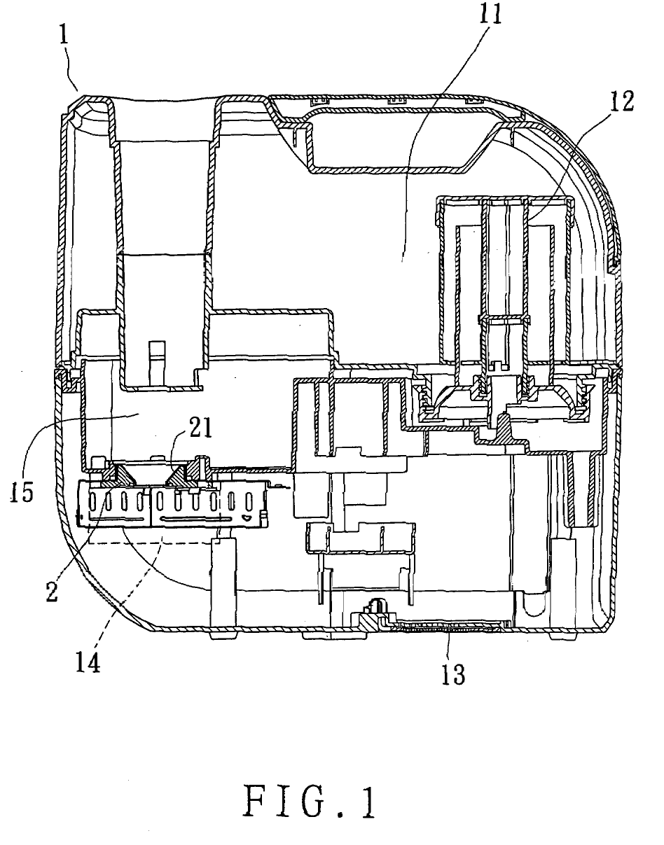

Referring to FIG. 1, a preferred embodiment of a humidifier 1 of the present invention includes a water storage tank 11, a filtering unit 12, a heating board 13, a piezoelectric crystal 14, a working tank 15, and a decay-free heat dissipating board 2. The water storage tank 11 contains a medium such as water, and the filtering unit 12 is disposed in the water storage tank 11. In use, water is made to flow to the heating board 13 through the filtering unit 12, and warmed by means of the heating board 13. Next, the warm water is sent to the working tank 15, wherein the warm water is vibrated and broken into molecules by means of ultrasonic waves produced by vibration of the piezoelectric crystal 14. Consequently, the water molecules dissolve in air, and sent out to the room to increase the humidity.

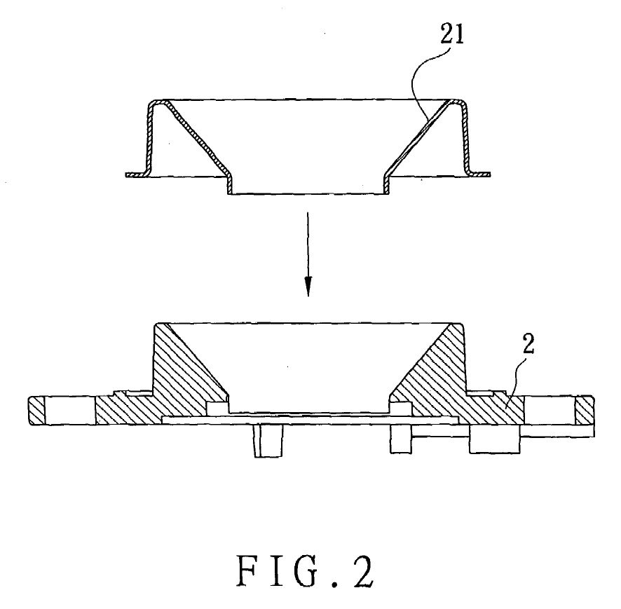

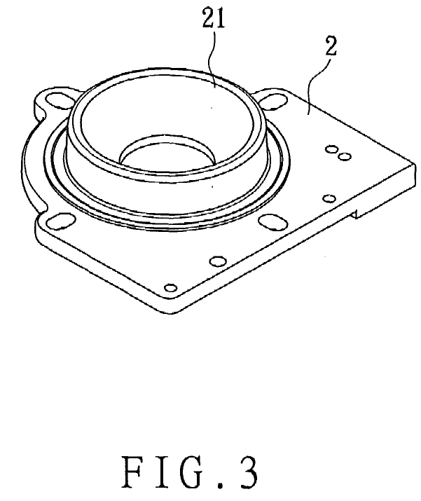

Referring to FIGS. 2 and 3 as well, the decay-free heating dissipating board 2 is disposed on an upper side of the piezoelectric crystal 14, and has a decay-prevention layer 21 secured on an upper side thereof to be in touch with water. The decay-prevention layer 21 can be made of stainless steel, and is secured in position by means of using roller pressing so as to make the decay prevention layer 21 recessed. Owing to the existence of the decay-prevention layer 21, the upper water-touched side of the heat dissipating board 2 is rust-free as well as decay-free.

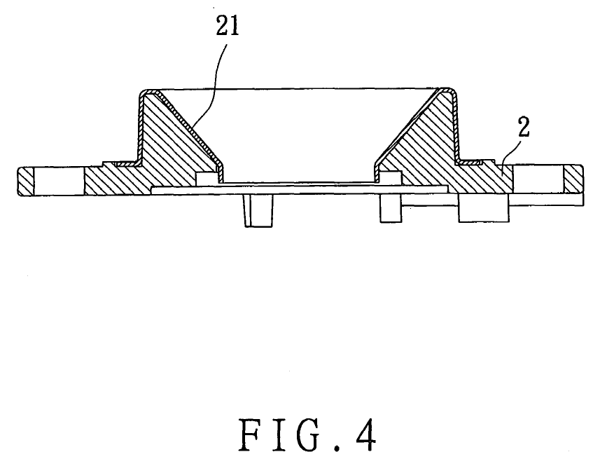

Referring to FIGS. 1, 2, and 4, in assembly, the working tank 15 is disposed inside the humidifier, and the piezoelectric crystal 14 is disposed under the working tank 15. And, the heat dissipating board 2 is interposed between the working tank 15 and the piezoelectric crystal 14 for helping to dissipate heat produced by the piezoelectric crystal 14.

From the above description, it can be seen that the present invention has the following advantages over the prior arts:

1. The humidifier has the decay-free heat dissipating board on the piezoelectric crystal, which can help to dissipate heat produced by the piezoelectric crystal effectively and efficiently.

2. The heat dissipating board of the humidifier has the decay-prevention stainless steel layer on the upper side to be in touch with water. Therefore, water can't cause the heat dissipating board to decay to reduce its heat dissipating capability.

3. The decay-prevention stainless steel layer is fixed to the upper side of the heat dissipating board by means of roller pressing and recessing the decay-prevention stainless steel layer. Therefore, it isn't possible for the decay-prevention layer to fall off of the heat dissipating board.

What is claimed is:

1. A decay-prevention structure of a heat dissipating board of a humidifier, said humidifier comprising
a storage tank for storing a medium,
a working tank,
a filtering unit, said filtering unit being positioned in said storage tank for filtering said medium before said medium is sent from said storage tank into said working tank;
a piezoelectric crystal for vibrating so as to produce ultrasonic waves to break a medium contained in said working tank into molecules dissolvable in air; and
a heat dissipating board interposed between an upper side of said piezoelectric crystal and said medium contained in said working tank so as to be in touch with said medium;
said heat dissipating board having a decay-prevention layer joined to an upper side thereof so as to be decay-free.

2. The decay-prevention structure of a heat dissipating board of a humidifier as recited in claim 1, wherein said medium is water.

3. The decay-prevention structure of a heat dissipating board of a humidifier as recited in claim 1, wherein said decay-prevention layer is made of stainless steel.

4. The decay-prevention structure of a heat dissipating board of a humidifier as recited in claim 1, wherein said decay-prevention layer is joined to said heat dissipating board by means of roller pressing.
